(19) United States
(12) Patent Application Publication
(10) Pub. No.: US 2007/0236793 A1
(43) Pub. Date: Oct. 11, 2007

(54) Polarization converter reflector

(76) Inventor: Daniel Lee Stark, San Jose, CA (US)

Correspondence Address: DANIEL LEE STARK, 1358 PIERCE RANCH ROAD, SAN JOSE, CA, 95120, US

(21) Appl. No.: 11/478,885

(22) Filed: Jul. 3, 2006

Related U.S. Application Data
(63) Continuation of application No. 11/397,179, filed on Apr. 5, 2006.

(51) Int. Cl. G02B 27/28

(52) U.S. Cl. 359/487; 359/483

(57) ABSTRACT

Disclosed are designs for a reflector optic that acts as a polarization converter optic, available in various combinations of the embodiments features, used to convert non polarized radiation into a single polarization state, which may be utilized in many devices requiring polarized radiation. Disclosed is a unique geometric configuration and positioning of optic substrates arranged as layers that cause polarization separation by radiation refraction and reflection and polarization conversion utilizing birefringent materials to convert incident radiation to a single linear polarization.

### CROSS REFERENCE TO RELATED APPLICATIONS

The present application is a continuation-in-part (CIP) of patent application Pub. No. US 2004/0145807 A1, filed Jul. 29, 2004 now U.S. Pat. No. 6,870,676, application Ser. No. 10/351,659 and patent application Ser. No. 11/397,179 of Apr. 5, 2006, all of which are incorporated herein in their entirety by reference.

### STATEMENT REGARDING FEDERALLY SPONSORED RESEARCH AND DEVELOPMENT

All research and development associated with this invention has been performed using private funds. No federally sponsored research or development has been used.

### BACKGROUND OF THE INVENTION

1. Field of Invention

The present invention relates to conversion of unpolarized electromagnetic radiation to a desired linear polarization, using the optical constructions and geometries described in the present invention.

2. Description of Related Art

Unpolarized light is described by random orientation of the electric field vector perpendicular to the radiation direction of travel, and corresponding magnetic field vector orthogonal to both the direction of travel and the electric field vector. Linear polarized light is characterized by a spatially constant orientation of the electric field vector and corresponding constant scalar magnitude.

The early art separates unpolarized electro magnetic radiation into polarized components. Historically a method to separate linearly polarized light was by applying Malus's law. Malus discovered in 1809 that light could be partially or completely polarized by reflection.

U.S. Pat. No. 2,403,731 provides a method to separate the polarization components utilizing multiple plates set at Brewster's angle, referred to as the MacNeille prism. MacNeille used seven layers of alternating high and low indices of refraction materials oriented to satisfy Brewster's angle to separate incident unpolarized light to a resultant linearly polarized light. The MacNeille prism further provides for the incident and exiting light to be normal to the prism's surface.

Another historical method to separate and produce linearly polarized light has been to use birefringent materials such as calcite. Birefringent materials at particular orientations exhibit differing indices of refraction, causing light transmitting through the crystal to be separated into two mutually perpendicular linearly polarized electric field vectors at different velocities and different refraction angles. The birefringent properties are utilized in U.S. Pat. No. 3,998,524, which provides a good, background and describes several prism types. One type of separator utilizes a polarization prism that also applies Brewster's law, and polarizes the incident light by total internal reflection of one of the two electric field vectors of the incident light at an interior surface, which is canted to the incident light at or beyond a selected critical angle. A second type utilizes a polarization prism, which transmits both electric field components of the incident light while physically separating them from each other at the output of the polarization prism in accordance to Snell's refraction law.

Some applications require separating the two orthogonal polarized electromagnetic radiations. One widely used technique for implementing this type of polarization prism is to cut one or more calcite crystals to form a Nicol or a Glan Thompson type prism. The resultant prism parts are then cemented together with an appropriate index of refraction adhesive. Another implementation of the calcite polarizer is to cement a layer of calcite or birefringent material between two glass prisms.

Other types of birefringent polarization prisms are the Wollaston and Rochon shearing polarizers. The polarizers produce two plane polarized, orthogonal, radiation paths with an angular separation between them at the same output surface of the polarization prism. In addition, the Wollaston polarizer disperses both polarizations of the incident light, and the Rochon polarizer yields only one half the angular separation of the polarized light beams of the Wollaston polarizer.

U.S. Pat. No. 2,270,535 Edwin Land, et al disclose a polarization converter comprised of a plurality of alternating layers where one layer is isotropic and the other alternating layer is birefringent. Furthermore the index of refractions and orientation of the birefringent layer is so selected that the index of refraction for the isotropic layer and birefringent layer is the same for electromagnetic radiation of a particular linear polarization, allowing the polarization to transit thru both layers of the optics without a polarization or direction change. The output is two linear orthogonal polarizations transmitted at different exit angles. Land further positions a phase rotator array to modify the polarization of one of the exit electromagnetic radiations to match the other. Disadvantage of this approach is the theoretical maximum of 75% for a narrow pass band of the radiation, which can be converted to like linear polarization. A further disadvantage is that the optic requires precise angular positioning of the birefringent layer with respect to input radiation. A further disadvantage is the exact requirements for the angular positioning and birefringent properties, dramatically restricting the choice of materials. Similarly material selection of both layers is inhibited by the requirement that both layers exhibit the same index of refraction for the selected polarization. The design also invokes use of Brewster's law, which restricts the dynamic of the conversion process both in bandwidth and overall conversion efficiency.

U.S. Pat. No. 2,868,076 W Gerfcken, et al discloses a polarization converter utilizing a plurality of alternating layers where in one layer exhibits a high index of refraction relative to the second layer. The layers are angled relative to the incident radiation so that Brewster's law is satisfied where 100% of the incident radiation of a particular linear polarization is reflected from the interface between layers 1 and 2 and directed to exit the optic. The orthogonal polarization refracts at the layer's interface and is directed to a double refractive foil causing a half wavelength phase shift. The polarizations exiting the optics both match. The disadvantage of this optic is the complexity of structures and high mechanical tolerance demands. Further the optic is designed to operate at Brewster's angle, which restricts the bandwidth and total conversion efficiency. A further disadvantage is that the double refractive foil must be constructed to a precise thickness and relative orientation in order to rotate the incident light vector exactly half wavelength.

U.S. Pat. No. 5,157,526 Kondo, et al discloses a polarization converter utilizing a plurality of alternating layers where in one layer exhibits a high index of refraction relative to the second layer. The polarization converter efficiency is stated as 1.4 better than conventional, 40%, which is only improvement to 60% conversion. The layers are angled relative to the incident radiation so that Brewster's law is satisfied where 100% of the incident radiation of a particular linear polarization is reflected from the interface between layers 1 and 2 and channeled down layer 1. The orthogonal polarization by Brewster's law is 100% transmitted into the second layer. The second layer is selected to be of birefringent material of a thickness along the electromagnetic radiation trace to cause a half wavelength electric field rotation exactly half wavelength. Thus half of the exiting radiation's polarization agrees with the radiation channeled down the first layer. Disadvantages of this invention are that the maximum theoretical efficiency for one interaction is 75% at a narrow pass band and the conditions of Brewster's law must be satisfied. A further disadvantage is that both alternating layers are selected to be birefringent materials, restricting the material selection. A disadvantage is that the birefringent layer must be constructed to a precise thickness and positioned to an exact orientation in order to rotate the incident light vector exactly half wavelength. The precision fabrication requirements drive up assembly costs and restrict the selection of materials. U.S. Pat. No. 5,157,526 Kondo, et al utilizes two reflections, but the design uses a single pass of the radiation's electric vector rotation, which automatically restricts maximum efficiency to 75%.

SEIKO EPSON (JP 01-265206) discloses a optic of isotropic and birefringent materials where the a birefringent layer causes the unpolarized input radiation to be split into two components at diverging angles, and focused via a micro-lens array onto an array of focus spots with mutually orthogonal linear polarization. Because the incoming radiation has different incoming angle onto the micro lens array, the lens produces an array of focus spots that are alternately orthogonal polarizations. A micro-array of phase shifting plates is positioned to rotate a set of focus points with like linear polarization to match the linear polarization of the other set. The main disadvantage of this approach is the complex high tolerance arrays, which drive fabrication costs up. Casting a polymer, which restricts the applications, best produces the lens array. The maximum theoretical efficiency is only 75% for a narrow wavelength.

Other polarization schemes that strive to convert the entire incident electromagnetic radiation into a single polarization have been referred to as doublers. U.S. Pat. No. 6,373,630 describes a polarization doubler. A polarization splitter film and a phase retardation film are used to focus and refract the incident radiation with an under plate. The radiation transiting the under plate, goes through a series of optical processes of polarization splitting, reflection, total reflection, phase retardation, and subsequently becomes radiation of a single polarization state output. A major disadvantage is a complex micro optic structure requiring precision manufacture, which results in a high manufacturing cost. The complex micro optic is best produced from a cast or plastic material, which limits the application capabilities.

U.S. Pat. No. 6,870,676, Stark, describes a layered polarization converter where in layers of high index and low index materials are arranged in a layered stack, with the high index material being birefringent. Radiation upon entering the edge of these layers has one linear polarization preferentially channeled thru the low index of material, while the other orthogonal polarization is selectively refracted thru the high birefringent layer and partially converted to the other linear polarization while transiting thru the high index polarization. Successive interactions cause the exiting polarization to be mostly converted into a single linear polarization. The optic is designed for wide band application, not requiring specific wavelength retardation coatings. The optic also prefers several interaction layers unlike the previous patents and functions at angles other than Brewster's angle.

U.S. application Ser. No. 11/397,179 of Apr. 5, 2006 describes a method of arranging the layered stacks described in U.S. Pat. No. 6,870,676 in a geometry that allows a thin construction as well as a colliminated output.

The present application is a continuation-in-part (CIP) of patent application Pub. No. US 2004/0145807 A1, filed Jul. 29, 2004 now U.S. Pat. No. 6,870,676, application Ser. No. 10/351,659 and patent application Ser. No. 11/397,179 of Apr. 5, 2006, all of which are incorporated herein in their entirety by reference.

### SUMMARY OF THE INVENTION

The first object of this present invention is to provide a reflector or mirror construction that utilizes the principles introduced by U.S. Pat. No. 6,870,676, and continuation described U.S. application Ser. No. 11/397,179 Stark, but can be utilized as a single or more than one reflector surface. Thus the first object of this invention is to provide a concept wherein a polarization converter optic may be constructed of a single mirror or reflector, which has the added advantage to preserves the incident incoming electromagnetic radiation divergence or columniation for both the reflected polarization component and polarization converted, reflected component, thus acting as both a mirror and a polarization converter.

The second object of the present invention is to provide a optic that may be constructed of many different substrates materials that allow construction of a thin optic as described in U.S. Pat. No. 6,870,676, and continuation described U.S. application Ser. No. 11/397,179 Stark. This patent specifically allows the substrate to be a high temperature tolerant metal, or silicon. The substrate supports manufacture of different high index materials such as anatase, ZnS and rutile.

### BRIEF DESCRIPTION OF THE DRAWINGS

The nature of this invention is to convert electromagnetic radiation into a selected polarization state. This invention provides significant advantages for many applications requiring polarized electromagnetic radiation. The present invention can be clearly understood from the following descriptions of the preferred embodiments in conjunction with the accompanying drawings, wherein

FIG. 1 is the preferred embodiment showing the arrangement of the single high index of refraction, birefringent substrate with a reflective layer on the second surface of the birefringent substrate;

FIG. 2 is an addition to the preferred embodiment, wherein the birefringent section of the optic is a optical coating applied to a substrate that acts as a reflector to radiation internal to the interface between the coating and the substrate, and the substrate acts to become the major structural member of the optic;

FIG. 3 shows an alternate design to the preferred embodiment wherein the substrate which acts as the supporting structure, and includes birefringent capability, has an additional optical layer of high index amorphous or isotropic optical characteristics over the birefringent optical layer, the second surface of the birefringent layer also acting as a mirror surface with a mirror coating;

FIG. 4 shows an alternate design wherein the birefringent coating or layer is applied to both sides of a substrate whose surfaces acts as a mirror on both sides, and the substrate acts as the main supporting medium;

FIG. 5 is an arrangement of multiple substrates arranged in a manner to form an array of radiation input apertures, a polarization conversion and channeling section between two substrates, and an array of radiation exit apertures;

FIG. 6 is an alternate configuration wherein the mirror substrates with birefringent coating or layers on both sides are shown as flat plates arranged in a simple parallel structure, as an array of radiation input apertures that channel and convert the incoming unpolarized electromagnetic radiation and exit at an array of radiation output apertures;

FIG. 7 is an alternate design wherein the mirrored substrates formed in parallel flat plates are arranged in a manner at the exit apertures to exit the radiation in a single direction, with the overall outside dimensions of the optic in the form of a wedge;

FIG. 8 is an alternate design wherein the layers formed in parallel flat mirrored plates are arranged in a staggered fashion at the input and output apertures to exit the radiation in a single direction as well as maintain a uniform thickness for the overall optic assembly.

### DETAILED DESCRIPTION OF THE INVENTION

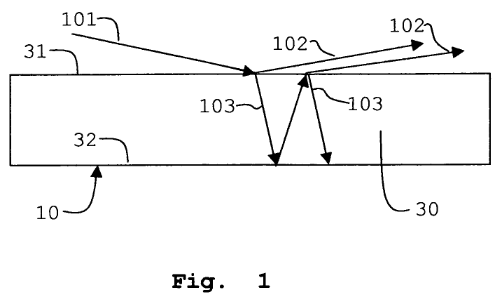

FIG. 1 Detailed Description

FIG. 1 shows a side view of the preferred embodiment, 10, in its most simple form. The substrate, 30, has two surfaces 31 and 32. The surface 31 is the input surface. Incident radiation, 101, is shown impinging on surface 31, with one linear polarization, 102, preferentially reflected, with orthogonal polarization, 103, preferentially refracted. The refracted radiation, 103, transverses the birefringent substrate, 30, impinges onto surface 32, which is treated to be reflective. Accordingly electromagnetic radiation 103 reflects from surface 32 and impinges onto surface 31, wherein the electromagnetic radiation 103 is both partially refracted to exit the substrate, and reflected to retransverse the substrate 30, repeating the cycle. The maximum conversion efficiency for a single or small number of interactive surfaces occurs where the electromagnetic radiation 101 is preferentially set at Brewster's angle with respect to surface 31, causing the reflected electromagnetic radiation 102 to be totally plane polarized, and the first electromagnetic radiation 103 to be plane polarized of the opposite polarization. High conversion efficiency is also obtained by angles less than Brewster's angle between surfaces 31 and 101, when multiple reflection refraction interactions are selected. By action of the birefringent crystal, electromagnetic radiation 103 polarization is modified to have both polarizations, and upon exiting the substrate adds to the plane polarization of the first electromagnetic radiation 101. Thus upon one interaction, the reflected electromagnetic radiations 102 may be up to 75% plane polarized for a narrow bandwidth.

Other angles with respect to Brewster's angle between electromagnetic radiation path 101 and substrate surface 31 also perform polarization conversion; however, more interactions are necessary to achieve conversion.

Multiple optics of the single optic as shown in FIG. 1 act to convert potentially 50% of the unconverted polarization at each interaction with the substrate, adding to the total converted polarization.

In order to preserve collimation, surfaces 31 and 32 are constructed parallel. However, a construction that is not parallel has the effect to separate the two beams, and has the effect of acting as a beam splitter to separate the two orthogonal polarizations at two different angles, which is a variation of the design.

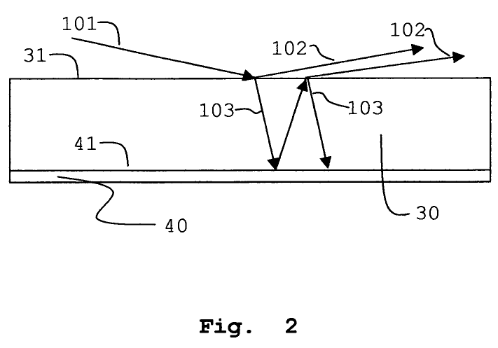

FIG. 2 Detailed Description

FIG. 2 shows a cross section of a variation of the preferred embodiment. A substrate 40 which may be a metal or a glass substrate material is shown with a layer of birefringent material 30 formed on the surface of substrate 40. The thickness of formed material 30 is shown exaggerated in necessary thickness in order to show the electromagnetic radiation paths. The incoming radiation 101 is shown with one polarization preferentially reflected, 102, and orthogonal radiation preferentially refracted, 103. The surface 41, formed by the contact of 30 and 40 is formed to be highly reflective. The layer 30 is selected to be highly birefringent with a high index of refraction and transparency in the desired wavelengths. Rutile and anatase are good selections for the visible because of the high index of refraction and high transparency to the visible. ZnS is a good selection for the IR. The impinging electromagnetic radiation 101, interacts with surface 31 by both reflecting of one preferred polarization as electromagnetic radiation 102, and refracting as electromagnetic radiation 103, of orthogonal polarization. If the angle between surface 31 and electromagnetic radiation 101 is set to Brewster's angle, the refracted electromagnetic radiation 103 and reflected electromagnetic radiation 102 are of totally opposite polarizations. However, Brewster's angle is dependent on wavelength; therefore, only works well in a very narrow bandwidth. The electromagnetic radiation transversing the coating 30, is acted upon by the birefringent crystal to undergo a polarization change, thus partially changing to the desired polarization. Electromagnetic radiation 103 upon interacting with surface 31 is both refracted and reflected, with the refracted electromagnetic radiation being partially polarized to the desired polarization. In an array designed for multiple reflection, conversion cycles the cycle is repeated, increasing the polarization conversion to a limit, mostly determined by the index of refraction of the high index first surface. Angles less than the critical angle yield the highest conversion for multiple interactions.

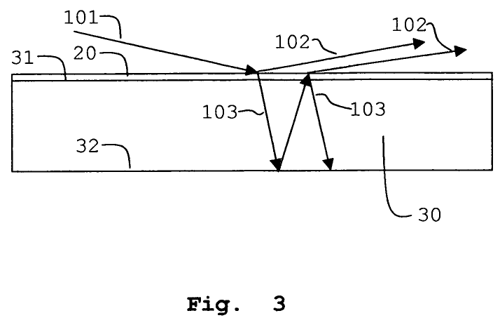

FIG. 3 Detailed Description

FIG. 3 shows a cross section of a variation of the preferred embodiment with the addition of a optical coating 20. The incoming radiation 101 is shown with one polarization preferentially reflected, 102, and orthogonal radiation preferentially refracted, 103. The coating 20 is of high index of refraction, and of amorphous or isotropic nature. The coating allows selection of materials of higher index of refraction and or materials that are amorphous than available for substrate 30, such as amorphous diamond. The coating 20 is selected to be preferably amorphous in order to eliminate polarization changes during reflection of electromagnetic radiation 101. The refracted electromagnetic radiation 103 is shown without reflection at the surface between 20 and 30, surface 31; however if an index of refraction difference exists between coating 20 and substrate 30, some reflection is expected at surface 31. A good material selection for visible application for 20 is an optical coating of amorphous diamond. The thickness of 20 is determined by maximizing the index of refraction, and the material as well as the method of deposition. The selection of 20 to be amorphous allows the optical axis of 30 not to be an issue caused by polarization shifts during reflection.

Selection of amorphous diamond for 20 allows the layer 20 to act as the main substrate structure.

Surface 32 is shown as a mirrored surface to reflect electromagnetic radiation 103.

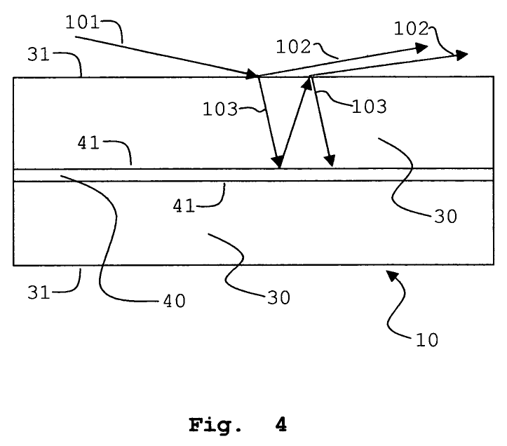

FIG. 4 Detailed Description

FIG. 4 shows a cross section of a preferred embodiment, 10 with additional options added to the design. A substrate 40, manufactured of a thin metal or other material is selected to have similar coefficient of thermal expansion characteristics as the optical birefringent coating, 30. The substrate, 40, is polished or coated to be a mirror on both sides shown as reflective surfaces, 41. Surface 41 may be designed to be a highly reflective dielectric mirror or a metallic polished surface to be highly reflective. The birefringent layer, 30, is shown exaggerated in thickness in order to show the interaction of electromagnetic radiation 103. The incoming radiation 101 is shown with one polarization preferentially reflected, 102, and orthogonal radiation, 103, preferentially refracted. Radiation 103 reflects off of surface 41, back to surface 31, partially reflecting, and adding to the preferred polarization, with the preferentially orthogonal polarization partially reflecting from surface 31 and repeating the cycle.

Layer 30, is maintained as thin as possible in order to minimize the walk of 103 along the optic substrate, and minimize absorption effects of layer 30. Not shown on the other side of substrate 41, is a similar electromagnetic radiation tracing.

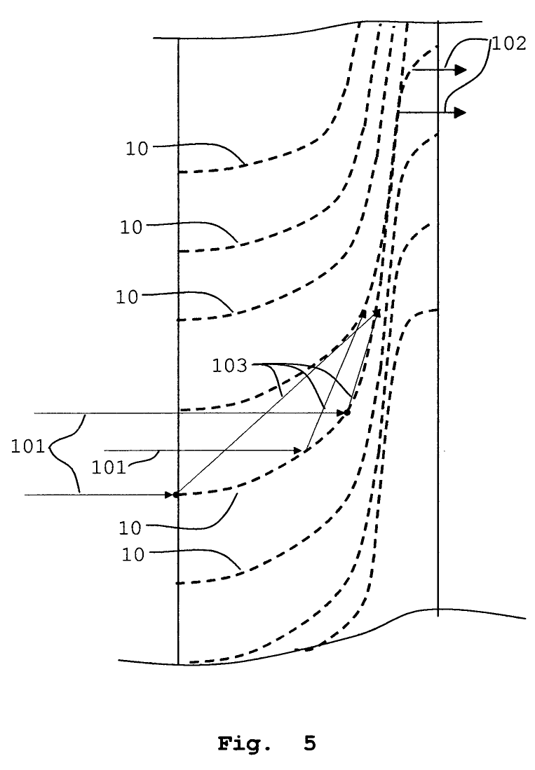

FIG. 5 Detailed Description

FIG. 5 shows an arrangement of the optical substrates 10, also referred to as elements. The elements, 10, are arranged in a manner to form an array of entrance apertures. The electromagnetic radiations 101, is shown for one aperture in the input aperture array. The electromagnetic radiation reflects multiple times between elements 10, arranged in layers, causing the polarization conversion. The electromagnetic radiation reflecting and refracting from the surface supported by elements 10, is shown as electromagnetic radiations 103. The refraction component being converted is not shown. At a single exit aperture in the exit aperture array, is shown exiting electromagnetic radiations 102. The form of the entrance aperture array is determined by the spacing of elements, 10. The elements 10, are positioned in a manner to channel the electromagnetic radiations at desired angle of intersection between the elements, 10. This angle is a function of the refractive index layer mounted on the element 10 substrate. The elements 10 are formed at the exit apertures to colliminate the exiting radiation 102. A desired divergence can also be formed by elements 10 at the exit aperture array. The construction shown in FIG. 5 allows multiple interactions in a narrow volume, and allows efficiency as to the number of elements 10 required to serve a larger entrance and exit aperture. The elements 10, are not shown with spacers, but as an option, micro beads of low index of refraction will maintain the elements 10, at a known, constant spacing.

The spacing between the elements 10, may be a gas, such as air, a liquid or a solid. The preferential selection is a gas such as air because it avoids the necessity for AR coatings at the entrance and exit apertures.

A low index of refraction material may also be utilized to form elements 10 spacing. Such a design has inherent manufacturing challenges and is more complex accordingly.

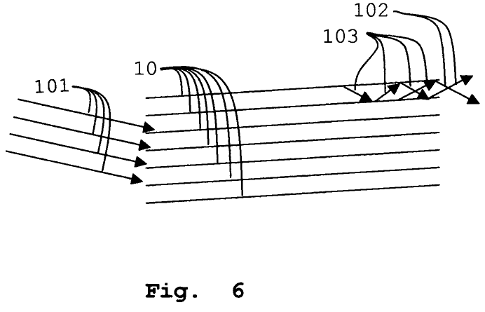

FIG. 6 Detailed Description

FIG. 6 is a geometric variation to the placement of substrates elements, 10. A pancake layer of substrates 10 are constructed with spacers, now shown. The spacers can be shims preferably placed at the ends or in a areas inside the active area of the optic. Micro beads placed in the active area form a spacer to maintain know distance between elements 10. The micro beads are preferably made from material with an index of refraction approaching one. The spacing between the layers 10, may be a gas, such as air, a liquid or a solid. The preferential selection is air because it avoids the necessity for anti reflective coatings at the entrance and exit apertures.

The exit radiation 102 is shown diverged by the nature of the geometry and reflections between the layers 10.

The electromagnetic radiation 103 is shown channeled between elements 10, while the polarization conversion occurs with each interaction at the surface of the layers 10.

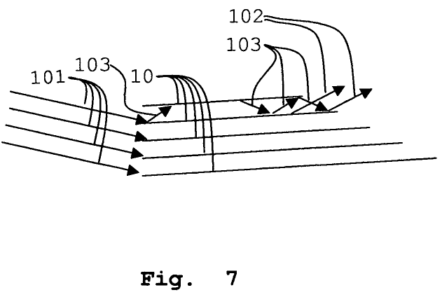

FIG. 7 Detailed Description

FIG. 7 is a variation of the parallel construction of elements 10, wherein the elements 10 are staggered at the exit aperture to cause the channeled electromagnetic radiation 103 to exit the optic as electromagnetic radiation 102 in a non diverged manner. The optic acts as a mirror, reflecting the incoming electromagnetic radiation 101 to exit the optic as electromagnetic radiation 102 as a mirror would reflect the electromagnetic radiation.

The optic's exterior dimensions forms a slight wedge because of the staggered layers 10.

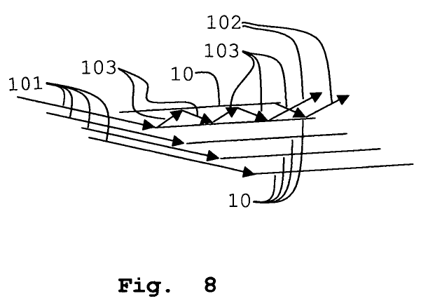

FIG. 8 Detailed Description

FIG. 8 is a variation of the parallel construction of elements 10, wherein the elements 10 are staggered at the entrance and exit apertures in order to construct an optic that conforms to a uniform thickness. Shown are the electromagnetic radiation tracing for the entering electromagnetic radiations 101, the channeled electromagnetic radiations 103, and the exiting electromagnetic radiations 102.

What is claimed is:

1. A polarization converter for converting electromagnetic radiation from a source into electromagnetic radiation having a prescribed polarized radiation state, said radiation source providing electromagnetic radiation resolvable into a two mutually orthogonal linear polarization states, comprising:
a high index of refraction substrate with the first surface of said high index substrate acts as a polarization separation mechanism, reflecting one component of said radiation of one polarization off of its surface, and refracting the orthogonal polarization into the substrate wherein the refracted orthogonal polarization is acted upon by the substrate's birefringent property to cause a polarization rotation, said refraction electromagnetic radiation being acted on by second surface of said substrate which is formed as a mirror to reflect the electromagnetic radiation back to the first surface of the substrate, with said radiation both refracting and reflecting from first surface, with said radiation adding to polarization of original reflected radiation from the first surface,
what is unique is a single substrate, that acts as both a mirror and a polarization converter,
what is unique is a single substrate wherein the first surface is utilized to separate the orthogonal polarizations, and the second substrate surface is used to reflect the refracted electromagnetic radiation through the substrate wherein said electromagnetic radiation is acted upon by birefringent material to rotate the polarization vector, wherein said reflected electromagnetic radiation upon interacting with first surface is both refracted and reflected, refracted electromagnetic radiation adding to preferred polarization component,
what is unique is the reflector is set at Brewster's angle for maximum conversion for one or more interactions.

2. The polarization converter of claim 1, further selects a variation or combinations of variations for a polarization converter for converting electromagnetic radiation from a source into electromagnetic radiation having a prescribed polarized radiation state, said radiation source providing electromagnetic radiation resolvable into a two mutually orthogonal linear polarization states, comprising:
a plurality of one or more reflective substrates, formed with a high index material formed on the surface of the substrate, the high index layer positioned to separate the electromagnetic polarization upon inter reaction at first surface of said high index layer and to preferentially reflect said electromagnetic radiation of preferred linear polarization and refract the orthogonal polarization into said layer's first surface wherein one or more layers formed on substrate is of birefringent nature to rotate the refracted polarization vector and to convert polarization and mirrored substrate surface arranged to reflect said radiation upon interaction with substrate's reflective surface back to substrate's first layered,
what is unique is substrate may be made of a metal or non-metallic substance to act as a mirror and substrate to position a birefringent coating,
what is unique is substrate my be a metal selected to have thermal coefficient of expansion very similar to rutile or anatase with said substrate allowing optical coating of rutile or anatase,
what is unique is substrate may be fashioned with birefringent material on both sides of the substrate to act by two adjacent substrates as a conduit channel between two adjacent layers
what is unique is substrate may have one or more layers of isotropic nature and high index of refraction combined with layers of birefringent nature to be the first surface on two or more layers on a single side of said substrate.

3. The polarization converter of claim 1, further selects a variation or combinations of variations for a polarization converter for converting electromagnetic radiation from a source into electromagnetic radiation having a prescribed polarized radiation state, said radiation source providing electromagnetic radiation resolvable into a two mutually orthogonal linear polarization states, comprising:
a plurality of two or more reflective substrates with a high index material formed on the surface, with high index material positioned to separate the electromagnetic polarization upon inter reaction at first surface of said high index material and to reflect said electromagnetic radiation one or more times between the alternating coated substrates, to channel electromagnetic radiation and refract the orthogonal polarization into said substrate's birefringent layer to convert polarization and reflect said radiation upon interaction with substrate's mirrored surface back to substrate's first surface for further reflection and refraction interactions, and reflect said electromagnetic radiation in a diverged or colliminated manner exiting the optic,
what is unique is an arrangement of substrates staggered at one or both of the entrance apertures and exit apertures to reflect the exiting radiation in a colliminated or diverged nature,
what is unique is an arrangement of substrates staggered at both entrance and exit apertures to maintain a constant overall optic thickness dimension.
